(19) United States
(12) Patent Application Publication
(10) Pub. No.: US 2026/0085191 A1
(43) Pub. Date: Mar. 26, 2026

(54) ZINC OXIDE-FUNCTIONALIZED CALCIUM CARBONATE COMPOSITE

(71) Applicant: Omya International AG, Oftringen (CH)

(72) Inventors: Jamal FTOUNI, Zofingen (CH); Ivan SCHLATTER, Zofingen (CH); Joachim GLAUBITZ, Murgenthal (CH)

(73) Assignee: Omya International AG, Oftringen (CH)

(21) Appl. No.: 19/109,228

(22) PCT Filed: Aug. 29, 2023
(86) PCT No.: PCT/EP2023/073668

§ 371 Date: Mar. 6, 2025

(30) Foreign Application Priority Data
Sep. 9, 2022 (EP) 22194855.7

(51) Int. Cl. C09C 1/02; A01N 25/04; A01N 59/16; A01P 1/00

(52) U.S. Cl. CPC C09C 1/024; A01N 25/04; A01N 59/16; A01P 1/00; C01P 2004/03; C01P 2004/80; C01P 2006/12

(57) ABSTRACT

The present invention relates to a method for producing a zinc oxide-functionalized calcium carbonate composite, a zinc oxide-functionalized calcium carbonate composite obtainable by a method, an article comprising the zinc oxide-functionalized calcium carbonate composite as well as the use of the zinc oxide-functionalized calcium carbonate composite in an aqueous preparation or in a solid article.

The present invention relates to a method for producing a zinc oxide-functionalized calcium carbonate composite, a zinc oxide-functionalized calcium carbonate composite obtainable by a method, an article comprising the zinc oxide-functionalized calcium carbonate composite as well as the use of the zinc oxide-functionalized calcium carbonate composite in an aqueous preparation or in a solid article.

In practice, aqueous preparations and especially suspensions, emulsions, dispersions or slurries of water-insoluble solids such as minerals, fillers or pigments are used extensively in the paper, paint, rubber, and plastics industries as coatings, fillers, extenders and pigments for papermaking as well as aqueous lacquers and paints. For example, suspensions or slurries of calcium carbonate, talc or kaolin are used in the paper industry in large amounts as filler and/or as a component in the preparation of coated paper. Furthermore, such aqueous preparations are also used as additives in the concrete and agriculture industries. Typical aqueous preparations of water-insoluble solids are characterized in that they comprise water, a water-insoluble solid compound and optionally further additives, such as dispersing agents, in the form of a suspension, a slurry or dispersion with a water-insoluble solid content of 0.1 to 99.0 wt.-% based on the total weight of the preparation. A typical aqueous preparation is a White Mineral Dispersion (WMD) having a solids content of 45.0 to 78.0 wt.-%. Water-soluble polymers and copolymers which may be used as e.g. dispersant and/or grinding aid in such preparation are, for example, described in U.S. Pat. No. 5,278,248.

The aforementioned aqueous preparations are often subject to destabilization during storing and handling and thus affecting mechanical and optical properties. Therefore, the manufacturers of such aqueous preparations usually take measures for stabilising the suspensions, dispersions or slurries by adding corresponding compounds and compositions. For example, pH stabilizing systems based on amines which are suitable for maintaining the pH of aqueous preparations are well known and widely used. However, the issue with such amines is that they may render the aqueous preparations very alkaline, i.e. above pH 12, which then necessitates specific work safety measures and specific labelling of the final products to be caustic. Furthermore, amines over time may undergo decomposition which may lead to a deterioration of the optical properties such as yellowing of the product and unpleasant smell.

Accordingly, it is an object of the present invention to provide a compound that is suitable for increasing the storage stability of articles such as aqueous preparations and solid articles. Another object of the present invention is to provide a method for preparing such compound. A further object of the present invention is to provide a storage stabilizing compound or composition without using amines. Another object of the present invention is to provide a process for stabilizing articles accordingly.

The foregoing objects and other objects are solved by the subject-matter as defined herein in the independent claims. Advantageous embodiments of the inventive method, the zinc oxide-functionalized calcium carbonate composite, the article and the use are defined in the corresponding sub-claims.

According to one aspect of the present invention, a method for producing a zinc oxide-functionalized calcium carbonate composite is provided. The method for producing a zinc oxide-functionalized calcium carbonate composite comprises the steps of.
a) providing a calcium carbonate-comprising material,
b) providing at least one water soluble or water dispersable source of zinc ions,
c) preparing under mixing an aqueous suspension comprising the calcium carbonate-comprising material of step a) and the at least one water soluble or water dispersable source of zinc ions of step b) and heating the aqueous suspension to a temperature of at least 60° C.,
d) drying the aqueous suspension of step c) to obtain a dried mixture, and
e) thermally treating the dried mixture obtained in step d) at a temperature ranging from 250 to 550° C. to obtain the zinc oxide-functionalized calcium carbonate composite.

According to one embodiment, the calcium carbonate-comprising material is selected from the group comprising natural ground calcium carbonate, synthetic precipitated calcium carbonate and mixtures thereof, preferably natural ground calcium carbonate.

According to another embodiment, the at least one water soluble or water dispersible source of zinc ions is at least one zinc salt, preferably a zinc salt selected from the group comprising zinc chloride, zinc sulfate, zinc nitrate, zinc citrate, zinc maleate, zinc acetate, zinc lactate, and mixtures thereof, preferably the zinc salt is zinc chloride.

According to yet another embodiment, the calcium carbonate-comprising material of step a) is provided in form of an aqueous suspension and/or the at least one water soluble or water dispersable source of zinc ions of step b) is provided in form of an aqueous suspension or an aqueous solution or a solid material.

According to one embodiment, the aqueous suspension of step c) is prepared by mixing the at least one water soluble or water dispersable source of zinc ions of step b), preferably mixing the at least one water soluble or water dispersable source of zinc ions of step b) as a solid material, into an aqueous suspension of the calcium carbonate-comprising material of step a).

According to another embodiment, the at least one water soluble or water dispersable source of zinc ions of step b) is present in an amount (measured as Zn ions) ranging from 1 to 40 wt.-%, based on the total weight of the calcium carbonate-comprising material, preferable from 3 to 35 wt.-% and most preferably from 5 to 30 wt.-%.

According to yet another embodiment, the heating in step c) is carried out at a temperature ranging from 60 to 100° C., preferably from 60 to 90° C. and most preferably from 60 to 75° C.

According to one embodiment, the drying in step d) is carried out by mechanical dewatering, filtration and/or evaporation.

According to another embodiment, the dried mixture has solids content ranging from 80 to 99.9 wt.-%, based on the total weight of the obtained mixture, preferably from 85 to 99.8 wt.-% and most preferably from 90 to 99.5 wt.-%.

According to yet another embodiment, the thermal treatment in step e) is carried out at a temperature ranging from 250 to 500° C. and most preferably from 250 to 450° C.

According to one embodiment, the zinc oxide-functionalized calcium carbonate composite has a BET specific surface area of from 1.0 to 70.0 m²/g, preferably from 1.0 to 65.0 m²/g, and most preferably from 1.0 to 60.0 m²/g, measured using nitrogen and the BET method according to ISO 9277.

According to another embodiment, the method comprises a further step f) of mixing the zinc oxide-functionalized calcium carbonate composite with a dispersing agent.

According to another aspect of the present invention, a zinc oxide-functionalized calcium carbonate composite obtainable by a method as defined herein is provided.

According to a further aspect of the present invention, an article being an aqueous preparation, preferably a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, coating, render, lacquer and/or a paint formulation, or a solid article, preferably a coating, paint film, lacquer or coating, paper coating, paper, paperboard, adhesive, sealant, pigment, fiber, plaster, plaster-spray, plasterboard, binder, thickener, gypsum and/or concrete, comprising the zinc oxide-functionalized calcium carbonate composite as defined herein is provided.

According to one embodiment, the article is an aqueous preparation comprising a dispersing agent.

According to a still further aspect of the present invention, the use of a zinc oxide-functionalized calcium carbonate composite as defined herein in an aqueous preparation, preferably a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, render, coating, lacquer and/or a paint formulation or in a solid article, preferably a coating, paint film, lacquer or coating, paper coating, paper, paperboard, adhesive, sealant, pigment, fiber, plaster, plaster-spray, plasterboard, binder, thickener and/or concrete is provided.

According to one embodiment, the zinc oxide-functionalized calcium carbonate composite increases the storage stability of the aqueous preparation or the solid article.

The inventors surprisingly found out that the foregoing method provides a compound that is suitable for increasing the storage stability of articles such as aqueous preparations and solid articles.

More precisely, the inventors found out that the storage stability for articles, such as aqueous preparation as well as solid articles, can be achieved if a zinc oxide-functionalized calcium carbonate composite is used.

It is to be noted that several attempts have been made to prepare composite materials comprising zinc oxide and calcium carbonate. For example, Anca Dumbrava et al: “Characterization and applications of a new composite material obtained by green synthesis, through deposition of zinc oxide onto calcium carbonate precipitated in green seaweeds extract”, CERAMICS INTERNATIONAL, ELSEVIER, AMSTERDAM, NL, vol. 44, no. 5, 13 Dec. 2017, pages 4931-4936, refers to a composite material obtained by depositing zinc oxide on calcium carbonate precipitated in green seaweeds extract. However, the method of Anca Dumbrava et al. does not only miss steps c), d) and e) as required by the present method but also requires the presence of additives such as polysaccharides that are missing in the present invention. Thus, the composite obtained by Anca Dumbrava et al. is not a result of a thermal treatment as required for the zinc oxide-functionalized calcium carbonate composite of the present invention but rather is a physical mixture of the components used. The composite obtained from such a physical mixture can be clearly differentiated from a composite that is obtained by a thermal treatment. In particular, the composite obtained from a physical mixture comprises rod-like particles of zinc oxide that are deposited on only a part of the calcium carbonate surface (see FIG. 2 of Anca Dumbrava et al. as well as FIG. 2 of the present invention). Contrary thereto, a composite obtained by a thermal treatment as required by the present invention provides a calcium carbonate surface that is fully functionalized/treated with the zinc species (see FIG. 1 of the present invention). It can be further gathered that Anca Dumbrava et al. discloses that zinc oxide powder is already added to a filtrate of specifically treated seaweed and thus does not require a thermal treatment to convert the zinc compound into zinc oxide. Contrary thereto, the present invention requires at least one water soluble or water dispersable source of zinc ions which is thermally converted into zinc oxide on the calcium carbonate surface to obtain the zinc oxide-functionalized calcium carbonate composite of the present invention.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

In the following, preferred embodiments of the inventive method will be set out in more detail. It is to be understood that these embodiments and details also apply to the inventive zinc oxide-functionalized calcium carbonate composite, the article and the use as far as applicable. Those skilled in the art will understand that many embodiments described herein can be combined or applied together.

### The Method for Producing a Zinc Oxide-Functionalized Calcium Carbonate Composite

According to step a) of the method, a calcium carbonate-comprising material is provided.

In one embodiment of the present invention, the calcium carbonate-comprising material is selected from the group comprising natural ground calcium carbonate, synthetic precipitated calcium carbonate and mixtures thereof. Thus, in one embodiment, the calcium carbonate-comprising material is natural ground calcium carbonate or synthetic precipitated calcium carbonate. In another embodiment, the calcium carbonate-comprising material is a mixture of natural ground calcium carbonate and synthetic precipitated calcium carbonate.

Preferably, the carbonate-comprising material is natural ground calcium carbonate.

“Natural ground calcium carbonate” (GCC) in the meaning of the present invention is a calcium carbonate obtained from natural sources, such as limestone, marble or chalk, and processed through a treatment such as grinding, screening and/or fractionizing by wet and/or dry, for example by a cyclone or classifier.

“Synthetic precipitated calcium carbonate” (PCC) in the meaning of the present invention is a synthesized material, generally obtained by precipitation following reaction of carbon dioxide and lime in an aqueous environment or by precipitation of a calcium and carbonate ion source in water.

Contrary to other uses of calcium carbonate-comprising materials, the material, preferably the natural ground calcium carbonate and/or synthetic precipitated calcium carbonate, is not surface treated and/or does not comprise a dispersing agent. Preferably, the calcium carbonate-comprising material, preferably the natural ground calcium carbonate and/or synthetic precipitated calcium carbonate, is not surface treated and does not comprise a dispersing agent.

It is to be noted that the synthetic precipitated calcium carbonate (PCC) of the present invention preferably differs from a calcium carbonate precipitated in green seaweeds extract.

Additionally or alternatively, the calcium carbonate-comprising material provided in step a) differs from a surface-reacted calcium carbonate as e.g. described in EP3275947 A1. Thus, the calcium carbonate-comprising material provided in step a) is preferably not a surface-reacted calcium carbonate. In particular, the calcium carbonate-comprising material provided in step a) is neither obtained by nor subjected to a treatment with at least one H₃O⁺ ion donor such as phosphoric acid and carbon dioxide in an aqueous medium and thus does not contain phosphate salts on its surface obtained from such a treatment. In view of this, the zinc oxide-functionalized calcium carbonate composite of the present invention is preferably free of phosphate salts. Thus, the calcium carbonate-comprising material provided in step a) is preferably not a surface-reacted calcium carbonate and the zinc oxide-functionalized calcium carbonate composite is preferably free of surface-reacted calcium carbonate.

Very generally, the calcium carbonate-comprising material may have a particle size distribution as conventionally employed for the material(s) involved in the type of product to be produced. In general, it is preferred that the calcium carbonate-comprising material has a weight median particle size d₅₀ value of from 0.1 to 5 μm, preferably from 0.2 to 2 μm and most preferably from 0.35 to 1 μm, for example 0.7 μm as measured using a Sedigraph™ 5120 of Micromeritics Instrument Corporation.

In one embodiment, the calcium carbonate-comprising material is provided in form of an aqueous suspension.

Thus, the aqueous preparation is preferably an aqueous suspension (or slurry).

It is appreciated that the solids content of the aqueous suspension can be up to 85.0 wt.-%. For example, the solids content of the aqueous suspension is from 05.0 to 82.0 wt.-%, preferably from 0.5.0 to 80.0 wt.-%, and most preferably from 0.5 to 60.0 wt.-%, based on the total weight of the aqueous suspension.

The total solids content in the meaning of the present invention corresponds to the residual weight of the aqueous preparation after drying for 3 h at 105° C. as measured in a sample of at least 3 to 5 g.

Typically, the aqueous suspension has a viscosity being preferably in the range from 50 to 2 000 mPa·s and preferably from 80 to 800 mPa·s, as measured with a Brookfield DV-II Viscometer at a speed of 100 rpm and equipped with a LV-3 spindle.

The aqueous suspension according to the invention can be produced by methods known in the art, by for example, dispersing, suspending or slurring the calcium carbonate-comprising material in water.

According to step b) of the method, at least one water soluble or water dispersable source of zinc ions is provided.

The term source of “at least one” water soluble or water dispersable zinc ions in the meaning of the present invention means that the source comprises, preferably consists of, one or more water soluble or water dispersable source(s) of zinc ions.

In one embodiment of the present invention, the water soluble or water dispersable source of zinc ions comprises, preferably consists of, one water soluble or water dispersable source of zinc ions. Alternatively, the water soluble or water dispersable source of zinc ions comprises, preferably consists of, two or more water soluble or water dispersable sources of zinc ions. For example, the water soluble or water dispersable source of zinc ions comprises, preferably consists of, two or three water soluble or water dispersable sources of zinc ions. Preferably, the water soluble or water dispersable source of zinc ions comprises, preferably consists of, one water soluble or water dispersable source of zinc ions

It is appreciated that the at least one water soluble or water dispersable source of zinc ions of step b) can be any material comprising, preferably consisting of, zinc ions as ions.

It is appreciated that the at least one source of zinc ions is water soluble or water dispersable.

Accordingly, the term “water soluble” or “soluble in water” in the meaning of the present invention refers to systems in which the source of zinc ions forms a solution with water, i.e. the particles of the at least one source of zinc ions are dissolved in the solvent. Alternatively, the term “water dispersable” or “dispersable in water” in the meaning of the present invention refers to systems in which only a part of the source of zinc ions forms a solution with water, i.e. only a part of the particles of the at least one source of zinc ions are dissolved in the solvent.

The term “source” of zinc ions in the meaning of the present invention refers to a compound that comprises zinc ions.

The at least one water soluble or water dispersable source of zinc ions is preferably at least one zinc salt. Preferably, the zinc salt is selected from the group comprising, preferably consisting of, zinc chloride, zinc sulfate, zinc nitrate, zinc citrate, zinc maleate, zinc acetate, zinc lactate, and mixtures thereof.

For example, the at least one zinc salt is zinc chloride.

In one embodiment, the at least one water soluble or water dispersable source of zinc ions is provided in form of an aqueous suspension or an aqueous solution, depending on the solubility of the at least one water soluble or water dispersable source of zinc ions in water. Alternatively, the at least one water soluble or water dispersable source of zinc ions is provided in form of a solid material.

It is appreciated that the content of the at least one water soluble or water dispersable source of zinc ions in the aqueous suspension or aqueous solution can be up to 85.0 wt.-%. For example, the content of the at least one water soluble or water dispersable source of zinc ions in the aqueous suspension or aqueous solution is from 05.0 to 82.0 wt.-%, preferably from 0.5.0 to 80.0 wt.-%, and most preferably from 0.5 to 60.0 wt.-%, based on the total weight of the aqueous suspension or aqueous solution.

The aqueous suspension or aqueous solution according to the invention can be produced by methods known in the art, by for example, dispersing, suspending, slurring or solving the at least one water soluble or water dispersable source of zinc ions in water.

According to step c) of the method, an aqueous suspension comprising the calcium carbonate-comprising material of step a) and the at least one water soluble or water dispersable source of zinc ions of step b) is prepared under mixing and the aqueous suspension is heated to a temperature of at least 60° C.

It is preferred that the aqueous suspension of step c) is prepared by mixing the at least one water soluble or water dispersable source of zinc ions of step b) into an aqueous suspension of the calcium carbonate-comprising material of step a).

The at least one water soluble or water dispersable source of zinc ions of step b) is added in form of an aqueous suspension or aqueous solution or solid material into the aqueous suspension of the calcium carbonate-comprising material of step a).

Preferably, the at least one water soluble or water dispersable source of zinc ions of step b) is added in form of a solid material into the aqueous suspension of the calcium carbonate-comprising material of step a).

In the aqueous suspension prepared in step c), the at least one water soluble or water dispersable source of zinc ions of step b) is present in an amount (measured as Zn ions) ranging from 1 to 40 wt.-%, based on the total weight of the calcium carbonate-comprising material.

Preferably, the at least one water soluble or water dispersable source of zinc ions of step b) is present in the aqueous suspension in an amount (measured as Zn ions) ranging from 3 to 35 wt.-% and most preferably from 5 to 30 wt.-%, based on the total weight of the calcium carbonate-comprising material.

It is preferred that the aqueous suspension comprising the calcium carbonate-comprising material of step a) and the at least one water soluble or water dispersable source of zinc ions of step b) is free of additives such as polysaccharides, and especially polysaccharides sodium salts, e.g. from green seaweeds. That is to say, the zinc oxide-functionalized calcium carbonate composite obtained by the method is preferably free of additives such as polysaccharides, and especially polysaccharides sodium salts, e.g. from green seaweeds.

It is appreciated that the aqueous suspension prepared in step c) is heated to a temperature of at least 60° C. in order to increase the interaction of the at least one water soluble or water dispersable source of zinc ions with the calcium carbonate-comprising material. Such increase in interaction is advantageous for improving the distribution and precipitation of the at least one water soluble or water dispersable source of zinc ions on the surface of the calcium carbonate-comprising material in drying step d).

Preferably, the heating in step c) is carried out at a temperature ranging from 60 to 100° C., preferably from 60 to 90° C. and most preferably from 60 to 85° C., e.g. from 60 to 75° C. In one embodiment, the heating in step c) is carried out at a temperature ranging from 65 to 100° C., preferably from 65 to 90° C. and most preferably from 65 to 85° C. In another embodiment, the heating in step c) is carried out at a temperature ranging from 70 to 100° C., preferably from 70 to 90° C. and most preferably from 70 to 85° C.

According to step d) of the method, the aqueous suspension of step c) is dried to obtain a dried mixture.

It is advantageous for the precipitation of the at least one water soluble or water dispersable source of zinc ions on the surface of the calcium carbonate-comprising material that the aqueous suspension obtained in step c) is dried before it is subjected to the thermal treatment in step e).

The drying of the aqueous suspension in step d) can be carried out by any means known for reducing the water content of an aqueous suspension. Thus, the drying in step d) is carried out by mechanical dewatering, filtration and/or evaporation. For example, drying step d) is carried out by mechanical dewatering.

The drying is preferably carried out such that the dried mixture has solids content ranging from 80 to 99.9 wt.-%, based on the total weight of the obtained mixture, more preferably from 85 to 99.8 wt.-% and most preferably from 90 to 99.5 wt.-%. That is to say, the dried material obtained in step d) has a moisture content ranging from 0.1 to 20 wt.-%, based on the total weight of the obtained mixture, more preferably from 0.2 to 15 wt.-% and most preferably from 0.5 to 10 wt.-%.

For example, the drying in step d) is carried out at a temperature ranging from 110 to 200° C., preferably from 110 to 190° C. and most preferably from 110 to 180° C., e.g. from 110 to 170° C. In one embodiment, the drying in step d) is carried out at a temperature ranging from 120 to 200° C., preferably from 120 to 190° C. and most preferably from 120 to 180° C., e.g. from 120 to 170° C. In another embodiment, the drying in step d) is carried out at a temperature ranging from 130 to 200° C., preferably from 130 to 190° C. and most preferably from 130 to 180° C., e.g. from 130 to 170° C.

In one embodiment, the drying in step d) is carried out by mechanical dewatering, filtration and/or evaporation, followed by a drying step that is carried out at a temperature ranging from 110 to 200° C., preferably from 110 to 190° C. and most preferably from 110 to 180° C., e.g. from 110 to 170° C. For example, the drying in step d) is carried out by mechanical dewatering, filtration and/or evaporation, followed by a drying step that is carried out at a temperature ranging from 120 to 200° C., preferably from 120 to 190° C. and most preferably from 120 to 180° C., e.g. from 120 to 170° C. For example, the drying in step d) is carried out by mechanical dewatering, filtration and/or evaporation, followed by a drying step that is carried out at a temperature ranging from 130 to 200° C., preferably from 130 to 190° C. and most preferably from 130 to 180° C., e.g. from 130 to 170° C.

Especially good result are obtained if the drying in step d) is carried out by mechanical dewatering, followed by a drying that is carried out at a temperature ranging from 110 to 200° C., preferably from 110 to 190° C. and most preferably from 110 to 180° C., e.g. from 110 to 170° C. For example, the drying in step d) is carried out by mechanical dewatering, followed by a drying step that is carried out at a temperature ranging from 120 to 200° C., preferably from 120 to 190° C. and most preferably from 120 to 180° C., e.g. from 120 to 170° C. For example, the drying in step d) is carried out by mechanical dewatering, followed by a drying step that is carried out at a temperature ranging from 130 to 200° C., preferably from 130 to 190° C. and most preferably from 130 to 180° C., e.g. from 130 to 170° C.

It is specifically required by the present invention that the dried mixture obtained in step d) is thermally treated at a temperature ranging from 250 to 550° C. to obtain the zinc oxide-functionalized calcium carbonate composite. The thermal treatment is decisive in order to convert the at least one water soluble or water dispersable source of zinc ions into zinc oxide and thus to prepare the zinc oxide-functionalized calcium carbonate composite.

According to step e) of the present invention, the method thus comprises step e) of thermally treating the dried mixture obtained in step d) at a temperature ranging from 250 to 550° C. to obtain the zinc oxide-functionalized calcium carbonate composite.

It is appreciated that a temperature above 250° C. is required to convert the at least one water soluble or water dispersable source of zinc ions into zinc oxide. However, a temperature of above 550° C. is to be avoided in order to prevent a (complete) transformation of the calcium carbonate-comprising material to calcium oxide.

In a preferred embodiment, the thermal treatment in step e) is carried out at a temperature ranging from 250 to 500° C. and most preferably from 250 to 450° C. For example, the thermal treatment in step e) is carried out at a temperature ranging from 275 to 500° C. and most preferably from 275 to 450° C. Alternatively, the thermal treatment in step e) is carried out at a temperature ranging from 300 to 500° C. and most preferably from 300 to 450° C. In a preferred embodiment, the thermal treatment in step e) is carried out at a temperature ranging from 310 to 400° C. and most preferably from 310 to 380° C.

The zinc oxide-functionalized calcium carbonate composite preferably has a BET specific surface area of from 1.0 to 70.0 m²/g, measured using nitrogen and the BET method according to ISO 9277. For example, the zinc oxide-functionalized calcium carbonate composite has a BET specific surface area of from 1.0 to 65.0 m²/g, and most preferably from 1.0 to 60.0 m²/g, measured using nitrogen and the BET method according to ISO 9277.

In one embodiment, the zinc oxide-functionalized calcium carbonate composite comprises natural ground calcium carbonate and has a BET specific surface area of from 1.0 to 60.0 m²/g, preferably from 1.0 to 40.0 m²/g, and most preferably from 1.0 to 30.0 m²/g, measured using nitrogen and the BET method according to ISO 9277. In another embodiment, the zinc oxide-functionalized calcium carbonate composite comprises synthetic precipitated calcium carbonate and has a BET specific surface area of from 10.0 to 70.0 m²/g, preferably from 20.0 to 65.0 m²/g, and most preferably from 30.0 to 60.0 m²/g, measured using nitrogen and the BET method according to ISO 9277.

In one embodiment, the zinc oxide-functionalized calcium carbonate composite has a weight median particle size d₅₀ of ≤20 μm, preferably ≤6 μm, more preferably ≤3 μm, and most preferably <2 μm. For example, the zinc oxide-functionalized calcium carbonate composite of the present invention has a weight median particle size d₅₀ of from 0.1 to 20 μm, preferably from 0.2 to 6 μm, more preferably from 0.4 to 3 μm, and most preferably from 0.5 to 2 μm.

Additionally or alternatively, the zinc oxide-functionalized calcium carbonate composite has a top cut particle size d₉₈ of ≤200 μm, preferably ≤20 μm, more preferably ≤10 μm, and most preferably <8 μm. For example, the zinc oxide-functionalized calcium carbonate composite of the present invention has a top cut particle size d₉₈ of from 0.5 to 200 μm, preferably from 1 to 20 μm, more preferably from 1.5 to 10 μm, and most preferably from 2 to 8 μm.

In one embodiment, the zinc oxide-functionalized calcium carbonate composite preferably has
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm.

Thus, the zinc oxide-functionalized calcium carbonate composite preferably has
a BET specific surface area of from 1.0 to 70.0 m²/g, preferably from 1.0 to 65.0.0 m²/g, and most preferably from 1.0 to 60.0 m²/g, measured using nitrogen and the BET method according to ISO 9277, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm.

In one embodiment, the zinc oxide-functionalized calcium carbonate composite may be provided together with a dispersing agent well known to the skilled person. Such dispersing agent is added for keeping the zinc oxide-functionalized calcium carbonate composite dispersed in an aqueous preparation and thus ensuring that the viscosity of the preparation remains substantially the same over time.

A suitable dispersing agent according to the present invention is preferably but not limited to a homo or copolymer made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, styrene, the esters of acrylic and methacrylic acids and mixtures thereof, wherein salts of poly(acrylic acid) and/or poly (methacrylic acid) are preferred as dispersing agent.

Thus, the method of the present invention may comprise a further step f) of mixing the zinc oxide-functionalized calcium carbonate composite with a dispersing agent.

In this embodiment, the method for producing a zinc oxide-functionalized calcium carbonate composite comprises the steps of.
a) providing a calcium carbonate-comprising material,
b) providing at least one water soluble or water dispersable source of zinc ions,
c) preparing under mixing an aqueous suspension comprising the calcium carbonate-comprising material of step a) and the at least one water soluble or water dispersable source of zinc ions of step b) and heating the aqueous suspension to a temperature of at least 60° C.,
d) drying the aqueous suspension of step c) to obtain a dried mixture,
e) thermally treating the dried mixture obtained in step d) at a temperature ranging from 250 to 550° C. to obtain the zinc oxide-functionalized calcium carbonate composite, and
f) mixing the zinc oxide-functionalized calcium carbonate composite with a dispersing agent.

Step f) of mixing the zinc oxide-functionalized calcium carbonate composite with a dispersing agent can be carried out by any method known in the art.

For example, the zinc oxide-functionalized calcium carbonate composite is dispersed in water with the addition of the dispersing agent.

### Composite, Articles and Uses

Another aspect of the present invention relates to a zinc oxide-functionalized calcium carbonate composite obtainable by a method as defined herein.

The zinc oxide-functionalized calcium carbonate composite of the present invention preferably has a BET specific surface area of from 1.0 to 70.0 m²/g, measured using nitrogen and the BET method according to ISO 9277. For example, the zinc oxide-functionalized calcium carbonate composite has a BET specific surface area of from 1.0 to 65.0 m²/g, and most preferably from 1.0 to 60.0 m²/g, measured using nitrogen and the BET method according to ISO 9277.

In one embodiment, the zinc oxide-functionalized calcium carbonate composite comprises natural ground calcium carbonate and has a BET specific surface area of from 1.0 to 50.0 m²/g, preferably from 1.0 to 40.0 m²/g, and most preferably from 1.0 to 30.0 m²/g, measured using nitrogen and the BET method according to ISO 9277. In another embodiment, the zinc oxide-functionalized calcium carbonate composite comprises synthetic precipitated calcium carbonate and has a BET specific surface area of from 10.0 to 70.0 m²/g, preferably from 20.0 to 65.0 m²/g, and most preferably from 30.0 to 60.0 m²/g, measured using nitrogen and the BET method according to ISO 9277.

In one embodiment, the zinc oxide-functionalized calcium carbonate composite of the present invention has a weight median particle size d₅₀ of ≤20 μm, preferably ≤6 μm, more preferably ≤3 μm, and most preferably ≤2 μm. For example, the zinc oxide-functionalized calcium carbonate composite of the present invention has a weight median particle size d₅₀ of from 0.1 to 20 μm, preferably from 0.2 to 6 μm, more preferably from 0.4 to 3 μm, and most preferably from 0.5 to 2 μm.

Additionally or alternatively, the zinc oxide-functionalized calcium carbonate composite of the present invention has a top cut particle size d₉₈ of ≤200 μm, preferably ≤20 μm, more preferably ≤10 μm, and most preferably ≤8 μm. For example, the zinc oxide-functionalized calcium carbonate composite of the present invention has a top cut particle size d₉₈ of from 0.5 to 200 μm, preferably from 1 to 20 μm, more preferably from 1.5 to 10 μm, and most preferably from 2 to 8 μm.

In one embodiment, the zinc oxide-functionalized calcium carbonate composite of the present invention preferably has
a weight median particle size d₅₀ of <20 μm, preferably ≤6 μm, more preferably ≤3 μm, and most preferably ≤2 μm, and
a top cut particle size d₉₈ of ≤200 μm, preferably <20 μm, more preferably ≤10 μm, and most preferably ≤8 μm.

Thus, the zinc oxide-functionalized calcium carbonate composite of the present invention preferably has
a BET specific surface area of from 1.0 to 70.0 m²/g, preferably from 1.0 to 65.0 m²/g, and most preferably from 1.0 to 60.0 m²/g, measured using nitrogen and the BET method according to ISO 9277, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm.

The zinc oxide-functionalized calcium carbonate composite is thus obtainable by a method comprising the steps of:
a) providing a calcium carbonate-comprising material,
b) providing at least one water soluble or water dispersable source of zinc ions,
c) preparing under mixing an aqueous suspension comprising the calcium carbonate-comprising material of step a) and the at least one water soluble or water dispersable source of zinc ions of step b) and heating the aqueous suspension to a temperature of at least 60° C.,
d) drying the aqueous suspension of step c) to obtain a dried mixture, and
e) thermally treating the dried mixture obtained in step d) at a temperature ranging from 250 to 550° C. to obtain the zinc oxide-functionalized calcium carbonate composite.

In one embodiment, the zinc oxide-functionalized calcium carbonate composite is provided together with a dispersing agent.

Thus, the zinc oxide-functionalized calcium carbonate composite is obtainable by a method comprising the steps of:
a) providing a calcium carbonate-comprising material,
b) providing at least one water soluble or water dispersable source of zinc ions,
c) preparing under mixing an aqueous suspension comprising the calcium carbonate-comprising material of step a) and the at least one water soluble or water dispersable source of zinc ions of step b) and heating the aqueous suspension to a temperature of at least 60° C.,
d) drying the aqueous suspension of step c) to obtain a dried mixture,
e) thermally treating the dried mixture obtained in step d) at a temperature ranging from 250 to 550° C. to obtain the zinc oxide-functionalized calcium carbonate composite, and
f) mixing the zinc oxide-functionalized calcium carbonate composite with a dispersing agent.

With regard to the definition of the method for producing the zinc oxide-functionalized calcium carbonate composite and preferred embodiments thereof, reference is made to the statements provided above when discussing the technical details of the method of the present invention.

The zinc oxide-functionalized calcium carbonate composite of the present invention increases the storage stability of an aqueous preparation or a solid article. Thus, the aqueous preparation or solid article can be any kind of article in need of storage stabilization.

More precisely, the article such as an aqueous preparation or a solid article comprises the zinc oxide-functionalized calcium carbonate composite.

It is appreciated that the zinc oxide-functionalized calcium carbonate composite is present in the article in an amount of at least 10 ppm, e.g. from 10 to 27 000 ppm, preferably at least 25 ppm, e.g. from 25 to 25 000 ppm, more preferably at least 50 ppm, e.g. from 50 to 20 000 ppm, still more preferably at least 60 ppm, e.g. from 60 to 15 000 ppm, even more preferably at least 75 ppm, e.g. from 75 to 10 000 ppm, and most preferably from 75 to 5 000 ppm, calculated relative to the total weight of the article.

It is appreciated that, if it is not indicated otherwise, the term “ppm” is calculated relative to the weight of the article, i.e. the aqueous preparation or the solid article.

In one embodiment, the article can be an aqueous preparation. The aqueous preparation is preferably a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, coating, render, lacquer and/or a paint formulation.

The aqueous preparation preferably comprises at least one inorganic particulate material.

The term “at least one” inorganic particulate material in the meaning of the present invention means that the inorganic particulate material comprises, preferably consists of, one or more inorganic particulate materials.

In one embodiment of the present invention, the at least one inorganic particulate material comprises, preferably consists of, one inorganic particulate material. Alternatively, the at least one inorganic particulate material comprises, preferably consists of, two or more inorganic particulate materials. For example, the at least one inorganic particulate material comprises, preferably consists of, two or three inorganic particulate material. Preferably, the at least one inorganic particulate material comprises, preferably consists of, one inorganic particulate material.

For example, the at least one inorganic particulate material is selected from the group comprising natural ground calcium carbonate, natural and/or synthetic precipitated calcium carbonate, dolomite, calcium sulphate, kaolin, clay, barite, talcum, quartz, mica, gypsum, aluminium hydroxide, aluminium silicate, titanium dioxide, magnesite, hydromagnesite, hydroxylapatite, perlite, sepiolite, brucite and mixtures thereof.

In one embodiment of the present invention, the at least one inorganic particulate material comprises natural ground calcium carbonate and/or synthetic precipitated calcium carbonate. Preferably, the at least one inorganic particulate material comprises natural ground calcium carbonate or synthetic precipitated calcium carbonate.

It is to be noted that hydromagnesite and brucite are either added as the first buffer component of the buffer composition or the at least one inorganic particulate material of the aqueous preparation. That is to say, if the aqueous preparation comprises hydromagnesite and/or brucite as the at least one inorganic particulate material, hydromagnesite and/or brucite is/are not included as the first buffer component in the buffer composition.

The natural ground calcium carbonate and/or synthetic precipitated calcium carbonate and/or surface-reacted calcium carbonate may additionally be surface treated well known to the skilled person.

If the aqueous preparation comprises at least one inorganic particulate material, the at least one inorganic particulate material may have a particle size distribution as conventionally employed for the material(s) involved in the type of product to be produced. In general, 90% of the particles will have an esd (equivalent spherical diameter as measured by the well-known technique of sedimentation using Sedigraph 5120 series, Micromeritics) of less than 5 μm. Coarse inorganic particulate materials may have a particle esd generally (i.e., at least 90 wt.-%) in the range of 1 to 5 μm. Fine inorganic particulate materials may have a particle esd generally less than 2 μm, e.g. 50.0 to 99.0 wt.-% less than 2 μm and preferably 60.0 to 90.0 wt.-% less than 2 μm. It is preferred that the at least one inorganic particulate material in the aqueous preparation has a weight median particle size d₅₀ value of from 0.1 to 5 μm, preferably from 0.2 to 2 μm and most preferably from 0.35 to 1 μm, for example 0.7 μm as measured using a Sedigraph™ 5120 of Micromeritics Instrument Corporation.

For keeping such inorganic particulate materials dispersed in an aqueous preparation and thus ensuring that the viscosity of the preparation remains substantially the same over time, additives such as dispersing agents can be used. For example, the dispersing agent is preferably a homo or copolymer made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, styrene, the esters of acrylic and methacrylic acids and mixtures thereof, wherein salts of poly(acrylic acid) and/or poly (methacrylic acid) are preferred as dispersing agent. Preferably, the dispersing agent is an acrylate-based dispersing agent.

Additionally or alternatively, the aqueous preparation comprises at least one organic particulate material. For example, the at least one organic material is selected from the group comprising carbohydrates such as starch, sugar, cellulose, modified cellulose and cellulose based pulp, glycerol, hydrocarbons, water-soluble polymers such as polyacrylates, and mixtures thereof.

It is appreciated that the solids content of the aqueous preparation can be up to 85.0 wt.-%. For example, the solids content of the aqueous preparation is from 05.0 to 82.0 wt.-%, preferably from 0.5.0 to 80.0 wt.-%, and most preferably from 0.5 to 60.0 wt.-%, based on the total weight of the aqueous preparation.

The total solids content in the meaning of the present application corresponds to the residual weight of the aqueous preparation after drying for 3 h at 105° C. as measured in a sample of at least 3 to 5 g.

30 It is to be noted that the aqueous preparation may comprise buffer components selected from the group comprising amine-based buffer components, monoalcohol-based buffer components, primary alkanol amine-based buffer components, hydroxide-based buffer components and mixtures thereof. For example, the aqueous preparation may comprise buffer components selected from the group comprising ammonia, methylamine, dimethylamine, trimethylamine, diethylamine, propylamine, butylamine, hexylamine, amino-2-methylpropanol (AMP), monoethanolamine (MEA), monoisopropanolamine (MIPA), triethylenetetramine (TETA), calcium hydroxide and mixtures thereof.

The pH of the aqueous preparation can vary in a broad range and is preferably in a pH range typically observed for such aqueous preparations. It is thus appreciated that the aqueous preparation preferably has a pH value of from 2 to 12. For example, the aqueous preparation of step a) has a pH value of from 6 to 11.5 and more preferably from 7 to 10.5.

Typically, the aqueous preparation has a viscosity being preferably in the range from 50 to 2 000 mPa·s and preferably from 80 to 800 mPa·s, as measured with a Brookfield DV-II Viscometer at a speed of 100 rpm and equipped with a LV-3 spindle.

The aqueous preparations according to the invention can be produced by methods known in the art, by for example, dispersing, suspending or slurring water-insoluble solids, preferably inorganic particulate materials with, if appropriate, addition of a dispersing agent and, if appropriate, further additives in water.

The aqueous preparation preferably has a pH equal to or below 12, preferably from 4 to 12, more preferably from 6 to 11.5 and most preferably from 8.5 to 10.5. Thus, it is appreciated that the article being an aqueous preparation has a pH value of equal to or below 12, preferably from 4 to 12, more preferably from 6 to 11.5 and most preferably from 8.5 to 10.5.

The aqueous preparation is preferably prepared by a process comprising the steps of
a) providing an aqueous preparation, preferably a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, coating, render, lacquer and/or a paint formulation,
b) providing a zinc oxide-functionalized calcium carbonate composite as defined herein, and
c) contacting and mixing the aqueous preparation of step a) one or more times with the zinc oxide-functionalized calcium carbonate composite of step b) for obtaining the aqueous preparation.

With regard to the definition of the zinc oxide-functionalized calcium carbonate composite and preferred embodiments thereof, reference is made to the statements provided above when discussing the technical details of the zinc oxide-functionalized calcium carbonate composite of the present invention.

According to step c) of the process of the present invention, the aqueous preparation of step a) is contacted and mixed with the zinc oxide-functionalized calcium carbonate composite of step b).

In general, the aqueous preparation of step a) and the zinc oxide-functionalized calcium carbonate composite of step b) can be brought into contact by any conventional means known to the skilled person.

It is appreciated that step c) is preferably carried out by adding the zinc oxide-functionalized calcium carbonate composite of step b) to the aqueous preparation of step a).

Preferably, step c) is carried out in that the zinc oxide-functionalized calcium carbonate composite is added to the aqueous preparation under mixing. A sufficient mixing may be achieved by shaking the aqueous preparation or by agitation, which may provide a more thorough mixing. In one embodiment of the present invention, step c) is carried out under agitation to ensure a thorough mixing of the aqueous preparation and the zinc oxide-functionalized calcium carbonate composite. Such agitation can be carried out continuously or discontinuously.

In one embodiment, step c) is carried out in that the zinc oxide-functionalized calcium carbonate composite is added to the aqueous preparation in an amount such that zinc oxide-functionalized calcium carbonate composite is present in the aqueous preparation in a total amount of at least 10 ppm, e.g. from to 27 000 ppm, preferably at least 25 ppm, e.g. from 25 to 25 000 ppm, more preferably at least 50 ppm, e.g. from 50 to 20 000 ppm, still more preferably at least 60 ppm, e.g. from 60 to 15 000 ppm, even more preferably at least 75 ppm, e.g. from 75 to 10 000 ppm, and most preferably from 75 to 5 000 ppm, calculated relative to the total weight of the aqueous preparation.

It is appreciated that step c) can be repeated one or more times.

The zinc oxide-functionalized calcium carbonate composite can be added in one or several portions to the aqueous preparation. If the zinc oxide-functionalized calcium carbonate composite is added in several portions, the zinc oxide-functionalized calcium carbonate composite can be added in about equal portions or unequal portions to the aqueous preparation.

The aqueous preparation obtained in step c) preferably has solids content corresponding to the solids content of the aqueous preparation provided in step a). It is thus appreciated that the aqueous preparation obtained in step c) preferably has solids content of up to 85.0 wt.-%, based on the total weight of the aqueous preparation obtained in step c). For example, the solids content of the aqueous preparation obtained in step c) is from 0.5 to 82.0 wt.-%, preferably from 0.5 to 80.0 wt.-%, and most preferably from 0.5 to 60.0 wt.-%, based on the total weight of the aqueous preparation obtained in step c).

In particular, the pH of the aqueous preparation obtained in step c) is preferably equal to or below 12, preferably from 4 to 12, more preferably from 6 to 11.5 and most preferably from 8.5 to 10.5.

Typically, the aqueous preparation obtained in step c) has a viscosity being preferably in the range from 50 to 2 000 mPa·s and preferably from 80 to 800 mPa·s, as measured with a Brookfield DV-II Viscometer at a speed of 100 rpm and equipped with a LV-3 spindle.

As already mentioned above, the zinc oxide-functionalized calcium carbonate composite of the present invention can be also used for increasing the storage stability of an article being a solid article. Thus, the article can be any kind of solid article in need of storage stabilization.

In one embodiment, the solid article can be a coating, paint film, lacquer or coating, paper coating, paper, paperboard, adhesive, sealant, pigment, fiber, plaster, plaster-spray, plasterboard, binder, thickener, gypsum and/or concrete.

In one embodiment, the solid article comprises the zinc oxide-functionalized calcium carbonate composite in a total amount of at least 10 ppm, e.g. from 10 to 27 000 ppm, preferably at least 25 ppm, e.g. from 25 to 25 000 ppm, more preferably at least 50 ppm, e.g. from 50 to 20 000 ppm, still more preferably at least 60 ppm, e.g. from 60 to 15 000 ppm, even more preferably at least 75 ppm, e.g. from 75 to 10 000 ppm, and most preferably from 75 to 5 000 ppm, calculated relative to the total weight of the solid article.

It is appreciated that the solid article is preferably obtained by drying, solidifying or hardening the aqueous preparation described above, i.e. a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, coating, render, lacquer and/or a paint formulation.

Thus, the solid article preferably comprises at least one inorganic particulate material. For example, the at least one inorganic particulate material is selected from the group comprising natural ground calcium carbonate, natural and/or synthetic precipitated calcium carbonate, dolomite, calcium sulphate, kaolin, clay, barite, talcum, quartz, mica, gypsum, aluminium hydroxide, aluminium silicate, titanium dioxide, magnesite, hydromagnesite, hydroxylapatite, perlite, sepiolite, brucite and mixtures thereof.

In one embodiment of the present invention, the at least one inorganic particulate material comprises natural ground calcium carbonate and/or synthetic precipitated calcium carbonate. Preferably, the at least one inorganic particulate material comprises natural ground calcium carbonate or synthetic precipitated calcium carbonate.

The natural ground calcium carbonate and/or synthetic precipitated calcium carbonate may additionally be surface treated or may comprise a dispersing agent well known to the skilled person.

If the solid article comprises at least one inorganic particulate material, the at least one inorganic particulate material may have a particle size distribution as conventionally employed for the material(s) involved in the type of product to be produced. In general, 90% of the particles will have an esd (equivalent spherical diameter as measured by the well-known technique of sedimentation using Sedigraph 5100 series, Micromeritics) of less than 5 μm. Coarse inorganic particulate materials may have a particle esd generally (i.e., at least 90 wt.-%) in the range of 1 to 5 μm. Fine inorganic particulate materials may have a particle esd generally less than 2 μm, e.g. 50.0 to 99.0 wt.-% less than 2 μm and preferably 60.0 to 90.0 wt.-% less than 2 μm. It is preferred that the at least one inorganic particulate material in the aqueous preparation has a weight median particle size d₅₀ value of from 0.1 to 5 μm, preferably from 0.2 to 2 μm and most preferably from 0.35 to 1 μm, for example 0.7 μm as measured using a Sedigraph™ 5100 of Micromeritics Instrument Corporation.

The solid article may further comprise dispersing agents. A suitable dispersing agent according to the present invention is preferably a homo or copolymer made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, styrene, the esters of acrylic and methacrylic acids and mixtures thereof, wherein salts of poly(acrylic acid) and/or poly (methacrylic acid) are preferred as dispersing agent.

It is preferred that the solid article comprises dispersing agents if the aqueous preparation, from which it is prepared, comprises a dispersing agent.

Additionally or alternatively, the solid article comprises at least one organic particulate material. For example, the at least one organic material is selected from the group comprising carbohydrates such as starch, sugar, cellulose, modified cellulose and cellulose based pulp, glycerol, hydrocarbons, water-soluble polymers such as polyacrylates, and mixtures thereof.

It is to be noted that the solid article may comprise buffer components selected from the group comprising amine-based buffer components, monoalcohol-based buffer components, primary alkanol amine-based buffer components, hydroxide-based buffer components and mixtures thereof. For example, the solid article may comprise buffer components selected from the group comprising ammonia, methylamine, dimethylamine, trimethylamine, diethylamine, propylamine, butylamine, hexylamine, amino-2-methylpropanol (AMP), monoethanolamine (MEA), monoisopropanolamine (MIPA), triethylenetetramine (TETA), calcium hydroxide and mixtures thereof. Typically, the buffer components are included before the present zinc oxide-functionalized calcium carbonate composite is added.

The solid articles according to the invention can be produced by methods known in the art by for example drying, solidifying or hardening the aqueous preparation described above, preferably a a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, coating, render, lacquer and/or a paint formulation.

The present invention also refers to a process for increasing the storage stability of a solid article, said process comprises the steps of
a) providing a solid article, preferably a coating, paint film, lacquer or coating, paper coating, paper, paperboard, adhesive, sealant, pigment, fiber, plaster, plaster-spray, plasterboard, binder, thickener, gypsum and/or concrete comprising the zinc oxide-functionalized calcium carbonate composite as defined herein, and
b) moisten the surface of the solid article of step a) for obtaining the stabilized solid article.

With regard to the definition of the zinc oxide-functionalized calcium carbonate composite and preferred embodiments thereof, reference is made to the statements provided above when discussing the technical details of the zinc oxide-functionalized calcium carbonate composite of the present invention.

According to step b) of the process of the present invention, the surface of the solid article of step a) is moisten for obtaining the stabilized solid article. That is to say, the moistening of the surface of the solid article results in a reactivation of the stabilizing capacity of zinc oxide-functionalized calcium carbonate composite of the present invention. Furthermore, it is to be noted that the solid article, without being moistened, does not provide a stabilizing capacity.

It is thus appreciated that the zinc oxide-functionalized calcium carbonate composite is preferably capable of maintaining the pH of the moisten solid article equal to or below 12, preferably from 4 to 12, more preferably from 6 to 11.5 and most preferably from 8.5 to 10.5, when the zinc oxide-functionalized calcium carbonate composite is present. This prevents the decrease of the stability on the surface of the solid article.

In general, the surface of the solid article of step a) can be moisten by any conventional means known to the skilled person.

It is appreciated that step b) is preferably carried out by contacting the surface of the solid article of step a) with water by e.g. wetting, spraying, condensing, brushing, dipping, immersing etc., or if the surface of the solid article of step a) is exposed to humidity or rain.

The amount of the zinc oxide-functionalized calcium carbonate composite added to the solid article can be individually adjusted depending on the solid article. The optimum amount to be employed within the defined ranges can be determined by preliminary tests and test series on a laboratory scale and by supplementary operational tests.

It is appreciated that step b) can be repeated one or more times.

The pH of the solid article obtained in step b) is equal to or below 12, preferably from 4 to 12, more preferably from 6 to 11.5 and most preferably from 8.5 to 10.5. In view of the goods results obtained, another aspect of the present invention refers to the use of a zinc oxide-functionalized calcium carbonate composite as defined herein in an aqueous preparation, preferably a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, render, coating, lacquer and/or a paint formulation or in a solid article, preferably a coating, paint film, lacquer or coating, paper coating, paper, paperboard, adhesive, sealant, pigment, fiber, plaster, plaster-spray, plasterboard, binder, thickener and/or concrete.

With regard to the definition of the article, the zinc oxide-functionalized calcium carbonate composite and preferred embodiments thereof, reference is made to the statements provided above when discussing the technical details of the article and the zinc oxide-functionalized calcium carbonate composite of the present invention.

It is appreciated that the zinc oxide-functionalized calcium carbonate composite increases the storage stability of the aqueous preparation or the solid article.

### DESCRIPTION OF THE FIGURES

FIG. 1 refers to a SEM of a zinc oxide-functionalized calcium carbonate composite.

FIG. 2 refers to a SEM of a sample being a blend of calcium carbonate with 10 wt. % of commercial Zinc oxide.

The scope and interest of the invention will be better understood based on the following examples which are intended to illustrate certain embodiments of the present invention and are non-limitative.

### EXAMPLES

The following measurement methods are used to evaluate the parameters given in the examples and claims.

### Scanning Electron Microscope (SEM)

The prepared samples were examined by a Sigma VP field emission scanning electron microscope (Carl Zeiss AG, Germany) and a variable pressure secondary electron detector (VPSE) and/or secondary electron detector (SE) with a chamber pressure of about 50 Pa.

### Particle Size Distribution

If not indicated otherwise, particle sizes such as the “d₅₀” and “d₉₈” values as used herein were determined as weight determined particle sizes by the sedimentation method, which is an analysis of sedimentation behaviour in a gravimetric field. The measurement was made with a Sedigraph™ 5120 of Micromeritics Instrument Corporation, USA. The method and the instrument are known to the skilled person and are commonly used to determine particle size distributions of fillers and pigments. The measurement was carried out in an aqueous solution of 0.1 wt % Na₄P₂O₇. The samples were dispersed using a high speed stirrer and supersonicated.

The processes and instruments are known to the skilled person and are commonly used to determine particle sizes of fillers and pigments.

### BET Specific Surface Area of a Material

The “specific surface area” (expressed in m²/g) of a material as used throughout the present document is determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 60 min prior to measurement. The total surface area (in m²) of said material can be obtained by multiplication of the specific surface area (in m²/g) and the mass (in g) of the material.

### Used Chemicals for Preparation of the Zinc Oxide-Functionalized Calcium Carbonate Composite:

Zinc sulfate heptahydrate (Z4750), zinc nitrate hexahydrate (228737), zinc chloride (211273) and zinc acetate (383317) from Sigma-Aldrich and distilled water. The used calcium carbonate grade (GCC) was OmyaCarb 1 AV from Omya international.

### Preparation of the Materials:

First phase of this work consisted on evaluating the impact of used zinc salt and thermal treatment step. For this evaluation, the used experimental protocol is described below:

In a bottom flask, 750 mL of distilled water was heated up to 80° C. 250 g of grounded calcium carbonate was dispersed and the slurry was maintained under mixing for 30 minutes. Zinc salt solution was solubilized in water. The mixture was maintained under mixing for 90 minutes. The amounts and volumes of the zinc salt solutions are set out in table 1.

TABLE 1

| | | Amount | |
|---|---|---|---|
| Name code of the | | of Zn | Water for |
| sample | Zn salt | salt (g) | salt (mL) |
| Sample A | ZnSO₄•7H₂O | 220 | 1100 |
| Sample B | Zn(NO₃)₂•6H₂O | 228 | 1140 |
| Sample C | Zn(CH₃COO)₂•2H₂O | 168 | 840 |
| Sample D | ZnCl₂ | 104 | 520 |

Subsequently, the slurry was filtered under pressure, the powder washed with distilled water (triple volume vis-à-vis slurry water volume) and dried overnight at 150° C. 10 g of the materials were after treated thermally at different temperatures (e.g. 300° C. and 450° C.) for 3 hours in a muffle oven under static air. The details are set out in table 2.

TABLE 2

| | | | | 1/100 plated on TSA | |
|---|---|---|---|---|---|
| | | | Zn wt. % | using P. aeruginosa | |
| | | | analyzed via | | T120 |
| | Thermal | | XRF | T48 hours | hours |
| Used metal salt | treatment T° C. | Label | technique | (cfu/plate) | (cfu/plate) |
| ZnSO₄•7H₂O | — | Sample A- | 17.8 | 1000 | 1000 |
| | | 150 | | | |
| | 300 | Sample A- | | 1000 | 1000 |
| | | 300 | | | |
| | 450 | Sample A- | | 1000 | 1000 |
| | | 450 | | | |
| Zn(NO₃)₂•6H₂O | — | Sample B- | 23.2 | 1000 | 1000 |
| | | 150 | | | |
| | 300 | Sample B- | | 1000 | 1000 |
| | | 300 | | | |
| | 450 | Sample B- | | 1000 | 1000 |
| | | 450 | | | |
| Zn(CH₃COO)₂•2H₂O | — | Sample C- | 16.7 | 1000 | 1000 |
| | | 150 | | | |
| | 300 | Sample C- | | 1000 | 1000 |
| | | 300 | | | |
| | 450 | Sample C- | | 1000 | 1000 |
| | | 450 | | | |
| ZnCl₂ | — | Sample D- | 22.3 | 1000 | 1000 |
| | | 150 | | | |
| | 300 | Sample D- | | 0 | 0 |
| | | 300 | | | |
| | 450 | Sample D- | | 50 | 1000 |
| | | 450 | | | |

The first analysis showed that the zinc materials produced using zinc chloride salt provided better antimicrobial properties especially when the material was treated thermally within the range of 250-550° C.

In the preparation below, the same preparation protocol was used for all samples. Zinc chloride was used as a zinc source. The details are set out in table 3.

TABLE 3

| | | | | Zn | | | | |
|---|---|---|---|---|---|---|---|---|
| | | | | wt. % | | Zinc | | |
| | Theoretical | | Thermal | analyzed | | oxide (%) | PSD | PSD |
| Sample | zinc | Slurry | treatment | via XRF | BET | analyzed | d₅₀ | d₉₈ |
| no. | wt. %(%) | T° C. | T° C. | technique | (m²/g) | via XRD | (μm) | (μm) |
| Sample 1 | 0 | 30 | 550 | 0 | 2.5 | 0 | 1.87 | 6.60 |
| Sample 2 | 10 | 30 | 325 | 6.9 | 8.4 | 8 | 1.31 | 5.73 |
| Sample 3 | 20 | 30 | 550 | 10 | 5.3 | 13 | 1.23 | 5.71 |
| Sample 4 | 0 | 100 | 100 | 0 | 4 | 0 | 1.72 | 6.36 |
| Sample 5 | 10 | 100 | 325 | 9.9 | 10.5 | 12 | 1.26 | 5.99 |
| Sample 6 | 20 | 30 | 100 | 8.5 | 18.7 | 0 | 1.40 | 5.85 |
| Sample 7 | 0 | 30 | 100 | 0 | 4.3 | 0 | 1.69 | 6.39 |
| Sample 8 | 20 | 100 | 100 | 19.4 | 27.6 | 0 | 1.21 | 5.65 |
| Sample 9 | 10 | 65 | 325 | 8.9 | 11.1 | 11 | 1.25 | 5.96 |
| Sample 10 | 10 | 65 | 325 | 8.4 | 11.7 | 11 | 1.29 | 5.95 |
| Sample 11 | 10 | 65 | 550 | 8.5 | 4.7 | 11 | 1.36 | 5.63 |
| Sample 12 | 20 | 65 | 325 | 17.6 | 21.7 | 22 | 1.14 | 5.55 |
| Sample 13 | 10 | 65 | 100 | 8.7 | 17.9 | 0 | 1.38 | 6.03 |
| Sample 14 | 20 | 100 | 550 | 19.6 | 7.2 | 25 | 1.04 | 6.19 |
| Sample 15 | 0 | 100 | 550 | 0 | 2.6 | 0 | 1.91 | 6.56 |
| Sample 16 | 0 | 65 | 325 | 0 | 4.2 | 0 | 1.70 | 6.56 |

It is to be noted that while using a high slurry temperature it was possible to decrease the difference between the theoretical and experimental (i.e real) loading of zinc. This effect can be attributed to the interaction increase of reagents at high temperature. Furthermore, the BET was inversely proportional to the thermal treatment temperature; BET decreases when the thermal treatment temperature increased. From XRD data, we also noticed a correlation with the thermal treatment temperature. The zinc oxide species, were seen only at temperatures above the 250° C.; below this value no species were seen. In contrast, at less than 250° C., side species such as smithsonite or hydrozincite were obtained. Showing that a thermal treatment temperature higher than 250° C. is essential to obtain the ZnO species.

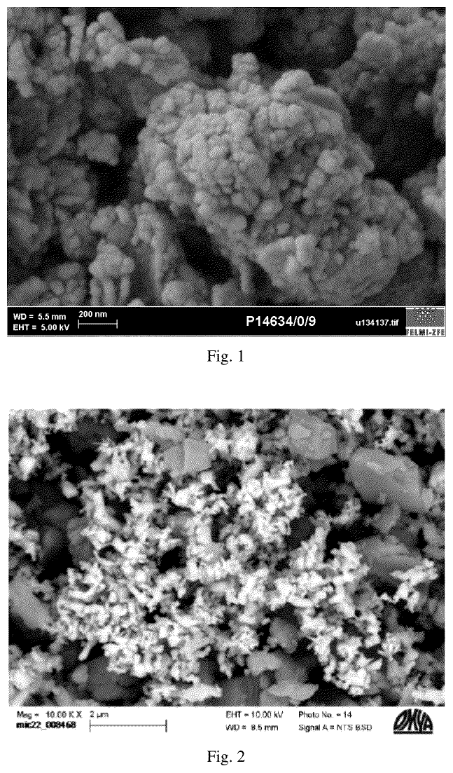

Also, it is noticed that the obtained materials differ clearly from a simple blend of the same calcium carbonate with a commercial zinc oxide species. FIG. 1 shows Sample 12. From FIG. 1, it can be gathered that the calcium carbonate's surface is fully functionalized/treated with the zinc species.

FIG. 2 shows a sample being a blend of calcium carbonate with 10 wt. % of commercial Zinc oxide. Contrary to the zinc oxide-functionalized calcium carbonate composite; the white is related to the zinc oxide and the grey is the calcium carbonate. In contrast, this difference cannot be seen in the treated materials as the calcium carbonate is decorated with the zinc oxide on its surface.

The foregoing is also confirmed by e.g. Anca Dumbrava et al: “Characterization and applications of a new composite material obtained by green synthesis, through deposition of zinc oxide onto calcium carbonate precipitated in green seaweeds extract”, CERAMICS INTERNATIONAL, ELSEVIER, AMSTERDAM, NL, vol. 44, no. 5, 13 Dec. 2017, pages 4931-4936. This document refers to a composite material obtained by depositing zinc oxide on calcium carbonate precipitated in green seaweeds extract such that the composite obtained is not a result of a thermal treatment but rather is a physical mixture of the components used. FIG. 2 of Anca Dumbrava et al. confirms that the composite obtained from such a physical mixture can be clearly differentiated from a composite that is obtained by a thermal treatment as required for the present invention. In particular, it can be gathered that the composite obtained from such a physical mixture comprises rod-like particles of zinc oxide that are deposited on only a part of the calcium carbonate surface (similar to FIG. 2 of the present invention).

### Used Material:

Trypic Soy Broth (TSB) (e.g. Sigma-Aldrich 22092)
Trypic Soy Agar (TSA) (e.g. ready made from Biomérieux)
PBS-buffer
Pseudomonas aeruginosa (DSM 1128)
Standard Incubators and shakers

### Preparation of the Overnight Cultures

Overnight cultures of the bacteria were prepared in 8 mL of TSB. The overnight cultures were incubated at 30° C.±2° C. for 18 h±2 h. The titer of the overnight cultures must be >1×10⁹ cfu/ml.

### Sample Preparation and Test Procedure:

OD₆₀₀ of overnight cultures was measured and adjusted to 0.0005 in 10 ml sterile TSB in a sterile 15 ml falcon tube. 50000 ppm of the test substances were added to the tubes with the bacteria (triplicates). The tubes were incubated at 30° C. with shaking (180 rpm). After 24 h, 48 h, 5d and 7d, 100 μl of the incubated samples were plated on TSA and incubated for 24 h at 30° C. to check how effective the antibacterial properties of the substances were (see Table X). At day 7, day 8 and Day 9 the equivalent amount of bacteria as T=0 was reintroduced to each sample to further challenge the system and evaluate the antibacterial properties. After 12 days the experiment was stopped and the pH of each sample was measured. The results are set out in table 4.

TABLE 4

| | Zn | Activation | preparation | | | | | | | | |
|---|---|---|---|---|---|---|---|---|---|---|---|
| | amount | Temp | Temp | T- | T- | T- | T- | T- | T- | T- | end |
| No. | [%] | [° C.] | [° C.] | 1 d | 2 d | 5 d | 7 d | 8 d | 9 d | 12 d | pH |
| Sample 1 | 0 | 550 | 30 | −− | −− | −− | −− | −− | −− | −− | 7.02 |
| Sample 2 | 10 | 325 | 30 | ++ | ++ | ++ | ++ | ++ | − | − | 7.63 |
| Sample 3 | 20 | 550 | 30 | −− | −− | −− | −− | −− | −− | −− | 7.48 |
| Sample 4 | 0 | 100 | 100 | −− | −− | −− | −− | −− | −− | −− | 7 |
| Sample 5 | 10 | 325 | 100 | ++ | ++ | ++ | ++ | ++ | + | − | 7.63 |
| Sample 6 | 20 | 100 | 30 | −− | −− | −− | −− | −− | −− | −− | 7.17 |
| Sample 7 | 0 | 100 | 30 | −− | −− | −− | −− | −− | −− | −− | 6.83 |
| Sample 8 | 20 | 100 | 100 | −− | −− | −− | −− | −− | −− | −− | 7.1 |
| Sample 9 | 10 | 325 | 65 | ++ | + | + | + | + | − | − | 7.48 |
| Sample 10 | 10 | 325 | 65 | ++ | ++ | + | + | + | −− | −− | 7.69 |
| Sample 11 | 10 | 550 | 65 | −− | −− | −− | −− | −− | −− | −− | 7.55 |
| Sample 12 | 20 | 325 | 65 | ++ | + | + | + | + | − | − | 7.86 |
| Sample 13 | 10 | 100 | 65 | −− | −− | −− | −− | −− | −− | −− | 7.09 |
| Sample 14 | 20 | 550 | 100 | ++ | −− | −− | −− | −− | −− | −− | 7.63 |
| Sample 15 | 0 | 550 | 100 | −− | −− | −− | −− | −− | −− | −− | 7.09 |
| Sample 16 | 0 | 325 | 65 | −− | −− | −− | −− | −− | −− | −− | 6.97 |
| GCC + ZnO | 15 | 600 | n/a | −− | −− | −− | −− | −− | −− | −− | n/a |
| GCC + ZnO | 25 | 600 | n/a | −− | −− | −− | −− | −− | −− | −− | n/a |

++ = no bacterial growth observed on all triplicates;
+ = two out of the three samples are clean;
− = 1 sample still is clean;
−− = all three samples are contaminated

### Results

The above experiment clearly shows that samples activated at 325° C. had the best antibacterial activity (see Table 4, samples 2, 5, 9, 10 and 12). And samples being activated at 100° C. or 550° C. show significantly less or none antibacterial activity, indicating that an activation temperature of about 250° C. is essential for this effect. If only GCC (OmyaCarb 1 AV) was activated at 325° C., no antibacterial effect was observed (see sample 16), clearly proving, that the presence of Zn and activation temperature ranging from 250 to 550° C. in combination are essential.

1. A method for producing a zinc oxide-functionalized calcium carbonate composite, the method comprising the steps of
a) providing a calcium carbonate-comprising material,
b) providing at least one water soluble or water dispersable source of zinc ions,
c) preparing under mixing an aqueous suspension comprising the calcium carbonate-comprising material of step a) and the at least one water soluble or water dispersable source of zinc ions of step b) and heating the aqueous suspension to a temperature of at least 60° C.,
d) drying the aqueous suspension of step c) to obtain a dried mixture, and
e) thermally treating the dried mixture obtained in step d) at a temperature ranging from 250 to 550° C. to obtain the zinc oxide-functionalized calcium carbonate composite.

2. The method according to claim 1, wherein the calcium carbonate-comprising material is selected from the group consisting of natural ground calcium carbonate, synthetic precipitated calcium carbonate and mixtures thereof.

3. The method according to claim 1, wherein the at least one water soluble or water dispersible source of zinc ions is at least one zinc salt.

4. The method according to claim 1, wherein the calcium carbonate-comprising material of step a) is provided in form of an aqueous suspension and/or the at least one water soluble or water dispersable source of zinc ions of step b) is provided in form of an aqueous suspension or an aqueous solution or a solid material.

5. The method according to claim 1, wherein the aqueous suspension of step c) is prepared by mixing the at least one water soluble or water dispersable source of zinc ions of step b).

6. The method according to claim 1, wherein the at least one water soluble or water dispersable source of zinc ions of step b) is present in an amount (measured as Zn ions) ranging from 1 to 40 wt.-%, based on the total weight of the calcium carbonate-comprising material.

7. The method according to claim 1, wherein the heating in step c) is carried out at a temperature ranging from 60 to 100° C.

8. The method according to claim 1, wherein the drying in step d) is carried out by mechanical dewatering, filtration and/or evaporation.

9. The method according to claim 1, wherein the dried mixture has solids content ranging from 80 to 99.9 wt.-%, based on the total weight of the obtained mixture.

10. The method according to claim 1, wherein the thermal treatment in step e) is carried out at a temperature ranging from 250 to 500° C.

11. The method according to claim 1, wherein the zinc oxide-functionalized calcium carbonate composite has a BET specific surface area of from 1.0 to 70.0 m²/g.

12. The method according to claim 1, wherein the method comprises a further step f) of mixing the zinc oxide-functionalized calcium carbonate composite with a dispersing agent.

13. A zinc oxide-functionalized calcium carbonate composite obtainable by a method according to claim 1.

14. An article being an aqueous preparation or a solid article, comprising the zinc oxide-functionalized calcium carbonate composite according to claim 13.

15. The article according to claim 14 being an aqueous preparation comprising a dispersing agent.

16. A method of using a zinc oxide-functionalized calcium carbonate composite, comprising the step of: adding the zinc-oxide functionalized calcium carbonate composite according to claim 13 in an aqueous preparation or in a solid article.

17. The method according to claim 16, wherein the zinc oxide-functionalized calcium carbonate composite increases the storage stability of the aqueous preparation or the solid article.

18. A method of increasing the storage stability of an aqueous preparation or a solid article, comprising adding the zinc oxide-functionalized calcium carbonate composite according to claim 13 to the aqueous preparation or the solid article.

19. The method according to claim 1, wherein the thermal treatment in step e) is carried out at a temperature ranging from 250 to 450° C.

20. The article of claim 14, wherein the aqueous preparation is a paper making formulation, a paper coating formulation, fibre formulation, plastic formulation, adhesive formulation, metal working fluid, cooling fluid, primer coat, levelling compound, pigment formulation, titanium dioxide slurry, concrete additives formulation, binder formulation, thickener formulation, plaster, coating, render, lacquer and/or a paint formulation; or wherein the solid article is a coating, paint film, lacquer or coating, paper coating, paper, paperboard, adhesive, sealant, pigment, fibre, plaster, plaster-spray, plasterboard, binder, thickener, gypsum and/or concrete.
